(19) United States
(12) Patent Application Publication
(10) Pub. No.: US 2015/0308252 A1
(43) Pub. Date: Oct. 29, 2015

(54) System and Method of Configuring Control Instructions for a Tool Assembly by Means of Machine Readable Component Information

(71) Applicant: Tracld AS, Stavanger (NO)

(72) Inventor: Mads Grinrod, Stavanger (NO)

(73) Assignee: Tracld AS, Stavanger (NO)

(21) Appl. No.: 14/412,954

(22) PCT Filed: Nov. 18, 2013
(86) PCT No.: PCT/NO2013/050200

§ 371 Date: Jan. 5, 2015

(30) Foreign Application Priority Data
Nov. 23, 2012 (NO) 20121409

(51) Int. Cl. E21B 44/00; G05B 19/04

(52) U.S. Cl. CPC E21B 44/00; G05B 19/041

(57) ABSTRACT

A system is for configuring control instructions for a tool assembly formed as a pipe string arranged at least partially to be inserted into a borehole, in which pipe string components are comprise unique, machine-readable identification carriers which are recognizable to a control system via one or more readers. The control system is linked to as database containing as component-data set for each pipe string component, and the control system is arranged to include the corresponding component-data set in a control-instruction set after a pipe string component has been recorded by a reader, in order thereby to generate control instructions for associated drilling-operation equipment in accordance with the relevant composition of the pipe string at any time. A method is for configuring control instructions for a tool assembly formed as a pipe string arranged at least partially to be inserted into a borehole is described as well.

### CROSS-REFERENCE TO RELATED APPLICATIONS

This application is the U.S. national stage application of International Application PCT/NO2013/050200, filed Nov. 18, 2013, which international application was published on May 30, 2014, as International Publication WO2014/081311 in the English language. The international application is incorporated herein by reference, in entirety. The international application claims priority to Norwegian Patent Application No. 20121409, filed Nov. 23, 2012, which is incorporated herein by reference, in entirety.

### FIELD

The invention relates to a system and a method of configuring control instructions for a tool assembly formed as a pipe string arranged to be inserted into a borehole, in which pipe string components are provided with unique, machine-readable identification carriers which are recognizable to a control system via one or more readers.

### BACKGROUND

When tool strings are used in boreholes et cetera, for example in hydrocarbon exploration and production, there is a need to have a complete overview of which elements are present in the tool string and where, in the borehole, important elements are, for example which type of drill bit a drill string is provided with and how far into the bore-hole the drill bit has been moved, so that correct operation of the tool is ensured, for example the running of the drill string being stopped before the drill bit hits the end of the borehole, and said drill bit being set into rotation at the right rotational speed. To get an overview of where the drill bit and other drill-string components are in the borehole, the lengths of pipes and components included In the drill string must be measured and recorded. Today, information on the elements included in the drill string is recorded manually in the control parameters by an operator. Relevant information is typically length, weight, outer diameter, inner diameter, thread type and required torque for screwing the components together. The recording of element data which, in addition, may have been collected manually on the drilling rig gives a possibility of several sources of error.

From the Norwegian patent NO 330526 it is known to use electronic tagging of elements that are used in a pipe string, the tagging being provided by means of an electronic tag of the RFID (Radio-Frequency IDentification) type which enables remote reading of the identity of the element so that an overview of the composition of the pipe string may be provided. This technique is used both to keep track of which elements the pipe string is composed of, that is to say which position the individual element has in the pipe string (the order within the pipe string), how many elements of a type have been used, for example how many drill-pipe sections a drill string contains, and some utilization data for each element, for example how long a time in service has been recorded for a particular drill-pipe section.

In the automation of operations connected to pipe strings that are run into a borehole or a well, the operation of the pipe string will be dependent on the separate operational parameters of the individual string elements, for example the position and orientation of the element before it is installed in the pipe string, and the supplier's instructions on rotational speed, maximum make-up torque during the connection to other pipe string elements, rates of advancement and rotational speed in the working phase of the element and so on. Such operational parameters must, of course, be included in the instructions available for the operation of the pipe string, for an automated operation in the form of parts of a control program, that is to say a computer program, for the system that is used for operating the pipe string.

Today, some operations are automated on the basis of the operations lying within what may be called a stable range, that is to say a range of operation in which the process does not have any moments of uncertainty, but is repetitive with the same operations and with the same equipment. Such an operation is, for example, lifting drill pipes in from a pipe deck to a drill floor and screwing them together into complete sections made up of two, three or more pipe lengths, after which the section is put back vertically into a pipe rack on the drill floor.

With the current technique, a wide range of such complete control programs is required, so that for all relevant element combinations in the pipe string, there is a corresponding control program. Viewed against the background of the construction of a pipe string being a dynamic activity, a situation may very easily arise in which the instructions defining how the pipe string is to be operated are not in agreement with the control parameters that the element supplier has defined for individual elements in the pipe string, for example because of a drill bit of another make than the one assumed in the control program having been fitted.

### SUMMARY

The invention has for its object to remedy or reduce at least one of the drawbacks of the prior art or at least provide a useful alternative to the prior art.

The object is achieved through features which are specified in the description below and in the claims that follow.

In the further description, the term “borehole” is used as a collective term for holes that are formed in an underground structure independently of whether the hole has not been completed or has been completed after the actual drilling operation. In this connection, the term “borehole” thus also covers a complete well bore in which casing, packers, sand screens and so on have been set.

The term “pipe string component” covers components that are integrated in a pipe string, for example a drill bit or a drill pipe, but may also be used for components that are connected to the pipe string, for example parts of cementation equipment which are placed on or at a drill floor and are connected to the pipe string by means of a cementation hose.

A system for configuring control instructions for a tool assembly by means of machine-readable element information, typically in the form of information provided by means of a component identification carried by an REID tag, has been provided. Every component that is used as a building element in a pipe string, which is to be inserted into or otherwise be connected to a borehole, carries a unique identification, for example connected to an RFID tag as it has been described in NO 330526. The identity of the pipe string component can be established by a reading in one or more places in the motion path of the pipe string component in towards the pipe string or during the displacement of the pipe string relative to the borehole, at least when the component is connected to the pipe string and passes a reader, for example in the immediate vicinity of the rotary table of a drill floor or on a blowout preventer (BOP). Further readers for reading the identity of the pipe string component may be placed in connection with manipulating equipment that moves pipe string components between a component rack and the pipe string.

For every pipe string component, a collection of data relating to handling and operation has been provided, for example minimum and/or maximum values for make-up torque, rotational speed, axial load, structural dimensions, thread dimension and so on. In addition, instructions, possibly including algorithms, are provided, defining how the pipe string component is to be operated, including restrictions when used alone or in combination with other specific pipe string components. Examples of restrictions may be a combination prohibition, maximum service life, requirements for ambient temperature or pressure, and so on. The component-specific data and instructions are arranged in a collection of information, typically a database, and is of a kind that can be retrieved and combined with other information and be included in a collection of instructions, typically a computer program, which is used for controlling equipment used when assembling and disassembling pipe strings, and for equipment which is used when the pipe string is being operated, for example a drilling machine, snubbing equipment and so on. The collection of instructions is updated continuously on the basis of the recording of pipe string components as they are installed in or removed from the pipe string, the positions of equipment running the pipe string into and out of the borehole, and is thus updated at all times on the composition of the pipe string and the positions of the individual pipe string components in the borehole. Additionally, the operation instructions of the control system are updated so that critical operation parameters, for example the rotational speed of a drill bit, are set in accordance with the instructions available on the use of the specific drill bit.

Changes in the instructions for a pipe string component, for example based on new information from the supplier or the operator's own experiences, may be made without touching the instructions for the pipe string as a whole, as the composition of the overall instructions for the pipe string is dynamic and is updated in accordance with the combination of components forming the pipe string at any time. When new components are introduced for use in the pipe string, the provision of instructions is limited to what relates to the new pipe string component as the instructions are provided in a form and structure compatible with the instructions for the other pipe string components.

In a first aspect, the invention relates more specifically to a system for configuring control instructions for a tool assembly formed as a pipe string arranged at least partially to be inserted into a borehole, in which pipe string components are provided with unique, machine-readable identification carriers which are recognizable to a control system via one or more readers, characterized by the control system being linked to a database containing a component-data set for each pipe string component, and by the control system being arranged to include the corresponding component-data set in a control-instruction set after a pipe string component has been recorded by a reader, in order thereby to generate control instructions for associated drilling-operation equipment in accordance with the relevant composition of the pipe string at any time.

The unique, machine-readable identification may be provided by an RFID tag, and the reader may be an RFID-tag reader.

The component-data sets may include limit values for relevant user parameters, relevant specifications and movement instructions for the corresponding pipe string component, and operative restrictions for combinations of one or more pipe string components.

In a second aspect, the invention relates more specifically to a method of configuring control instructions for a tool assembly formed as a pipe string arranged at least partially to be inserted into a borehole, characterized by the method including the following steps:

a) providing a database containing component-data sets for pipe string components which may form part of the pipe string;

b) linking the database to a control system for associated drilling-operation equipment;

c) providing the pipe string components with unique, machine-readable identification carriers;

d) by means of one or more readers, identifying and establishing the position of a pipe string component relative to the pipe string;

e) completing the control-instruction set of the control system for associated drilling-operation equipment with a component-data set for the pipe string component, in order thereby to generate control instructions in accordance with the changed composition of the pipe string.

### BRIEF DESCRIPTION OF THE DRAWING

In what follows, an example of a preferred embodiment will be described, which is visualized in the accompanying drawing, in which:

FIG. 1 shows a principle drawing of an automated drilling-rig arrangement according to the invention.

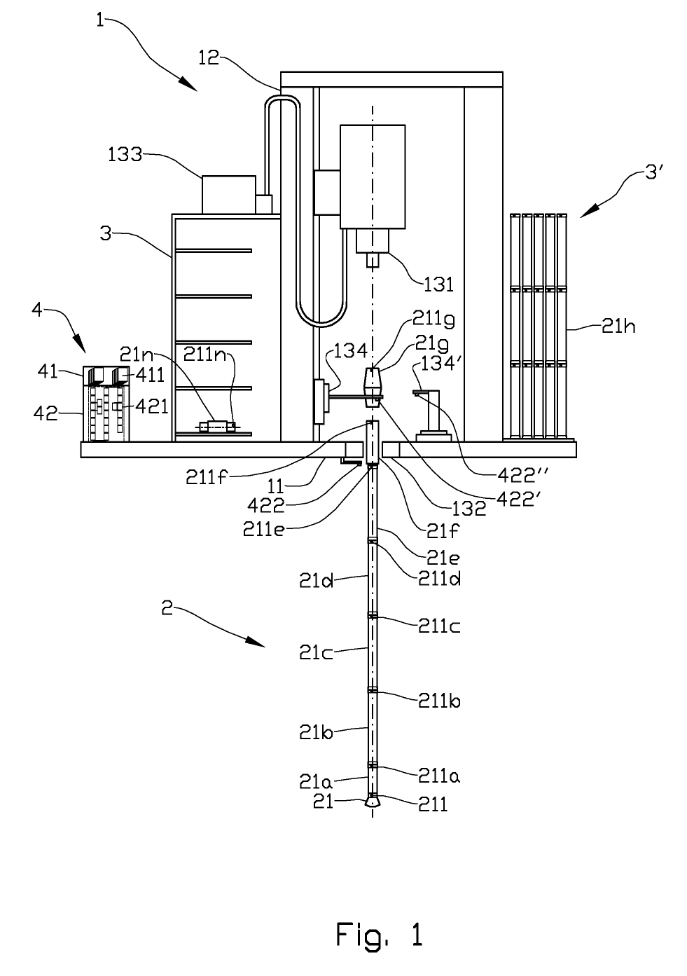

### DETAILED DESCRIPTION OF THE DRAWING

In the figure, the reference numeral 1 indicates a drilling rig in which a derrick 12 projects from a drill floor 11. The drilling rig 1 is provided with drilling-operation equipment of various types, shown here with means for rotating a pipe string 2, typically a rotary table 132 arranged in the drill floor and a drilling machine 131 which also represents equipment used for the axial displacement of the pipe string 2, further a circulation system 133 for drilling fluid and so on, and manipulators or robots 134, 134′ for manipulating pipe string components and so on in connection with the operations on the drill floor 11.

The pipe string 2, which extends through the rotary table of the drill floor 11 and down into a borehole (not shown), is composed of various types of pipe string components, shown here with the reference numerals 21, 21a, 21b, 21c, 21d, 21e and 21f. A further pipe string component 21g is shown in a position immediately above the pipe string 2 ready to be joined to the pipe string 2. A further pipe string component 21n is placed in a first component rack 3. A further component rack 3′ is shown containing several pipe string components 21h, shown here as standing drill-pipe sections, that is to say several drill pipes screwed together into so-called “stands”.

All the pipe string components, 21, 21a, . . . , 21n are provided with machine-readable identification carriers 211, 211a, . . . 211n, typically in the form of RFID tags. If appropriate, a pipe string component 21, 21a, . . . , 21n may be provided with several identification carriers (not shown), for example to give indications on the orientation, extent and so on of the pipe string component 21, 21a, . . . , 21n.

A control system 4 comprising a database 41 and a control system 42 is connected in a signal-communicating manner to the drilling-operation equipment 131, 132, 133, us 134, 134′. The database 41 is arranged to store user instructions and component data gathered into component-data sets 411 for all the pipe string components 21, 21a, . . . , 21n, each component-data set 411 including information connecting it to a corresponding pipe string component 21, 21a, . . . , 21n on the basis of the unique identification of the pipe string component 21, 21a, . . . , 21n provided for the database 41 by there being at least one reader 422 connected to the control system 4, which can read the information with which the identification carriers 211, 211a, 211b, . . . , 211n are provided. Here, the reader 422 is shown arranged in the immediate vicinity of the pipe string 2 just below the rotary table 132, but it may also be appropriate to connect several readers 422′, 422″ to the control system 4, shown in the figure in connection with the manipulator 14 and the robot 134′, respectively.

In an embodiment not shown, the database 41 may be located remote from the control system 42, for example centrally with an operator, as the database 41 is shared by many control systems 42.

By means of a control-instruction set 421, the control system 42 controls the operations which are performed with the drilling-operation equipment 131, 132, 133, 134, 134′. The control-instruction set 421 is of a kind which is updated with component-data sets 411 from the database 41 in accordance with what pipe string components 21, 21a, . . . , 21n are installed in, possibly removed from, the pipe string 2. The control-instruction set 421 is thereby dynamic and based on the recordings made by the control system 4.

An example of how the invention functions can be illustrated by the following situation: A pipe string 2 in the form of a drill string is constructed. As the drill bit 21 is moved past the reader 422, the drill bit 21 is identified, and the corresponding component-data set 411 which may include recommended load on the drill bit 21 and limit values for the load, recommended rotational speed for the drill bit 21 and limit values for that, is loaded into the control-instruction set 421 of the control system 42, so that when the drilling starts, this is done in accordance with the values that apply to the drill bit 21 which has been recorded as fitted in the pipe string 2.

Another example of the use of the invention is illustrated by the following: A tool in the form of a setting tool 21n which is to be used for the installation of a component (not shown) in a well is picked up from the component rack 3 and connected to the pipe string 2. The control-instruction set 421 is supplemented with information on where and how the component is to be installed, for example 450 metres below a wellhead (not shown) by the setting tool 21n performing three right-hand rotations and then being lifted 2 metres in order then to be loaded with an axial load of 20 tonnes before the pipe string 2 is rotated ¼ turn towards the left, and the setting tool 21n is pulled out of the borehole and returned to the component rack 3. The instructions on where the tool 21n is to set the component, is fed into the control system 42, whereas the instructions on how the setting tool is to be operated are fed into the control system 42 from the database 41 as specific user instructions via the component-data set 411 for the setting tool 21n.

In a situation in which new types or makes of pipe string components 21, 21a, . . . , 21n are to be adopted, the database is updated with new component-data sets 411. If new pipe string components 21, 21a, . . . , 21n of the same types as those used earlier are put to use, for example new drill pipes, theft identities are connected to existing component-data sets 411.

The invention also relates to components that are connected to the pipe string 2 but are not lowered into the borehole, the components being connected to a portion of the pipe string 2 projecting above the drill floor 11, possibly including elements which are arranged on or in the immediate vicinity of the drill floor 11. An example of such components is those that are used in a cementing operation. A cementation head (not shown) is such a component, as this will be placed on the top of the pipe string 2 above the drill floor 11 with connection to a cement reservoir (not shown) via a cementing hose (not shown).

With a system of this kind, the automation of drilling operations, well-completion operations and so on may be carried out in a more flexible way as, when there is a supplement of new equipment, there is no need to reprogram the entire control-instruction set 421, and so the entire control program, controlling the process.

1. A system for configuring control instructions for a tool assembly formed as a pipe string arranged at least partially to be inserted into a borehole, in which pipe string components are provided with unique, machine-readable identification carriers which are recognizable to a control system via one or more readers, wherein the control system is linked to a database containing a component-data set for each pipe string component, and the control system is arranged to include the corresponding component-data set in a control-instruction set after a pipe string component has been recorded by a reader, in order thereby to generate control instructions for associated drilling-operation equipment in accordance with the relevant composition of the pipe string at any time.

2. The system in accordance with claim 1, wherein the unique, machine-readable identification comprises an RFID tag, and the reader is an RFID-tag reader.

3. The system in accordance with claim 1, wherein the component-data set comprises limit values for relevant user parameters, relevant specifications and movement instructions for the corresponding pipe string component, and operative restrictions for combinations of one or more pipe string components.

4. A method of configuring control instructions for a tool assembly formed as a pipe string arranged at least partially to be inserted into a borehole, wherein the method comprises:
a) providing a database containing component-data sets for pipe string components which may form pad of the pipe string;
b) linking the database to a control system for associated drilling-operation equipment;
c) providing the pipe string components with unique, machine-readable identification carriers;
d) with one or more readers, identifying and establishing the position of a pipe string component relative to the pipe string; and
e) completing the control-instruction set of the control system for associated dolling-operation equipment with a component-data set for the pipe string component in order thereby to generate control instructions in accordance with the changed composition of the pipe string.
